(19) United States
(12) Patent Application Publication
(10) Pub. No.: US 2013/0094712 A1
(43) Pub. Date: Apr. 18, 2013

(54) SYSTEMS AND METHODS FOR EYE TRACKING USING RETROREFLECTOR-ENCODED INFORMATION

(71) Applicant: Amir Said, Cupertino, CA (US)

(72) Inventor: Amir Said, Cupertino, CA (US)

(21) Appl. No.: 13/806,559

(22) PCT Filed: Jul. 16, 2010
(86) PCT No.: PCT/US2010/042237

§ 371 Date: Dec. 21, 2012

(51) Int. Cl. G06K 9/32

(52) U.S. Cl. CPC G06K 9/3241
USPC 382/103

(57) ABSTRACT

Embodiments of the present invention are directed to eye tracking systems and methods that can be used in uncontrolled environments and under a variety of lighting conditions. In one aspect, an eye tracking system (200) includes a light source (204) configured to emit infrared (“IR”) light, and an optical sensor (206) disposed adjacent to the light source and configured to detect IR light. The system also includes one or more retroreflectors (210) disposed on headgear. The one or more retroreflectors are configured to reflect the IR light back toward the light source. The reflected IR light is captured as IR images by the optical sensor. The IR images provide information regarding the location and head orientation of a person wearing the headgear.

### TECHNICAL FIELD

Embodiments of the present invention relate to eye tracking.

### BACKGROUND

Eye tracking is a method that can be used to determine or measure the position of the eyes of a person looking at a displayed image, relative to the display screen. One technique for eye tracking is to use computer vision face detection methods, and visible light cameras, to identify the user's eye position. While this technique can exploit a great amount of widely available hardware and software, eye tracking with face detection is not suitable for a wide variety of environments and lighting conditions. For example, face detection cannot be performed in a dark or dimly lighted room. Other types of eye tracking methods include detecting light, typically infrared light, reflected from the eye and sensed by a video camera or some other specially designed optical sensor. The information is then analyzed to extract eye position or head rotation from changes in reflections. Other types of eye trackers use the corneal reflection or the center of the pupil as features to track over time.

Many eye-tracking methods and systems also cannot be used to accurately determine whether a person has moved farther away from an eye-tracking system or simply turned has turned his/her head. For example, FIG. 1A shows a top view of person located at position 1 in front of an eye-tracking system 101. Because the person is facing the system 101, the system 101 can determine an approximate distance dᵥ of the person from the system 101 based on measuring the distance between the person's eyes dₑ in an image captured by the system 101. FIG. 1B shows a top view of the person located at position 1 but with the person's head turned away from the system 101. The person is still an approximate distance dᵥ from the system 101, but because the person's head is turned, the eye-tracking system 101 captures an image of the person's face at an angle. As a result, the system 101 incorrectly determines that the distance between the person's eyes is dₑ₁, which is smaller than dₑ. The system 101 assumes the person is facing the system when the distance dₑ₁ is measured and incorrectly determines that the person is located farther away from the system 101 at position 2 with an associated distance of approximately dᵥ₁. In other words, using face detection with eye tracking, the system 101 is unable determine head orientation and mistakenly determines that the person has moved farther away from the system 101 when in fact the person may have just turned his/her head.

Users of head and eye tracking technologies continue to seek methods and systems for accurately determining a person's location and head orientation under a wide variety of light conditions and uncontrolled environments.

### BRIEF DESCRIPTION OF THE DRAWINGS

FIG. 1A shows a top view of a person located at a position in front of an eye-tracking system.

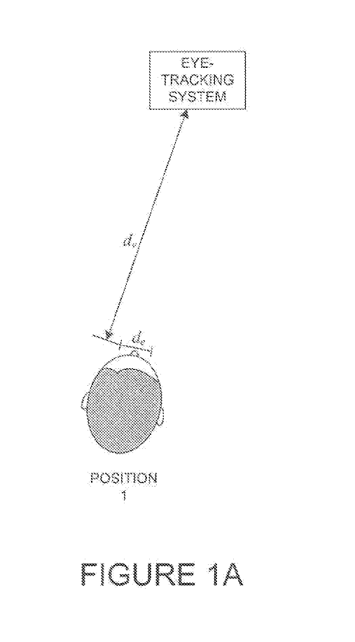

FIG. 1B shows a top view of a person located at a first position and the same person located at a second position but with the person's head in different orientations.

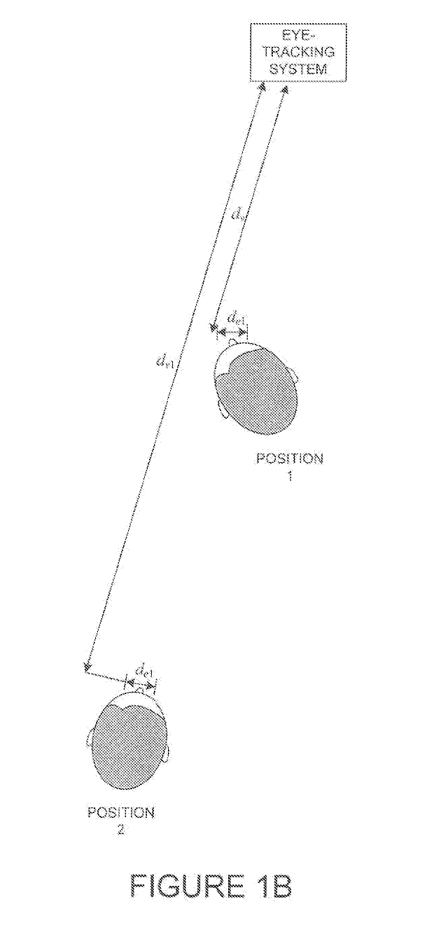

FIG. 2 shows an example of an eye-tracking system configured in accordance with one or more embodiments of the present invention.

FIG. 3 shows a top plan view and example of the eye-tracking system used to enhance a three-dimensional viewing experience in accordance with one or more embodiments of the present invention

FIGS. 4A-4B show consecutive images captured by an optical sensor and used to identify the location of a person in accordance with one or more embodiments of the present invention.

FIG. 5A-5B show consecutive images captured by an optical sensor and used to identify the location of a person in accordance with one or more embodiments of the present invention.

FIG. 6 shows an isometric view of glasses configured with a particular pattern of retroreflectors in accordance with one or more embodiments of the present invention.

FIG. 7 shows an isometric view of glasses configured with retroreflectors that each reflect light with an identifiable shape in accordance with one or more embodiments of the present invention.

FIG. 8A shows an isometric view of glasses configured with retroreflectors in accordance with one or more embodiments of the present invention.

FIGS. 8B-8C show cross-sectional views of two kinds of retroreflectors operated in accordance with embodiments of the present invention.

FIG. 9 shows an example of using retroreflectors that reflect light with different shapes when a person's head is in different orientations in accordance with embodiments of the present invention.

FIG. 10 shows an example of using retroreflectors that reflect light with different patterns when a person's head is in different orientations in accordance with one or more embodiments of the present invention.

FIG. 11 shows a flow diagram summarizing a method of eye tracking in accordance with one or more embodiments of the present invention.

### DETAILED DESCRIPTION

Embodiments of the present invention are directed to eye tracking systems and methods that can be used in uncontrolled environments and under a wide variety of lighting conditions. Embodiments of the present invention enhance reliability at a low cost by making detection easier with infrared (“IR”) retroreflectors and specially shaped markers, and active illumination, where image differencing can eliminate spurious reflections. Embodiments of the present invention also include using retroreflectors to encode information that can be translated into head orientation.

Although eye tracking systems and methods of the present invention have a wide variety of applications, for the sake of convenience and brevity, system and method embodiments are described for use in stereoscopic viewing. In particular, tracking the spatial position and orientation of a person's head while viewing a monitor or television can be an effective way of enabling realistic three-dimensional visualization, because eye tracking enables head-motion parallax, and when combined with stereoscopy can create an enhanced three-dimensional viewing experience.

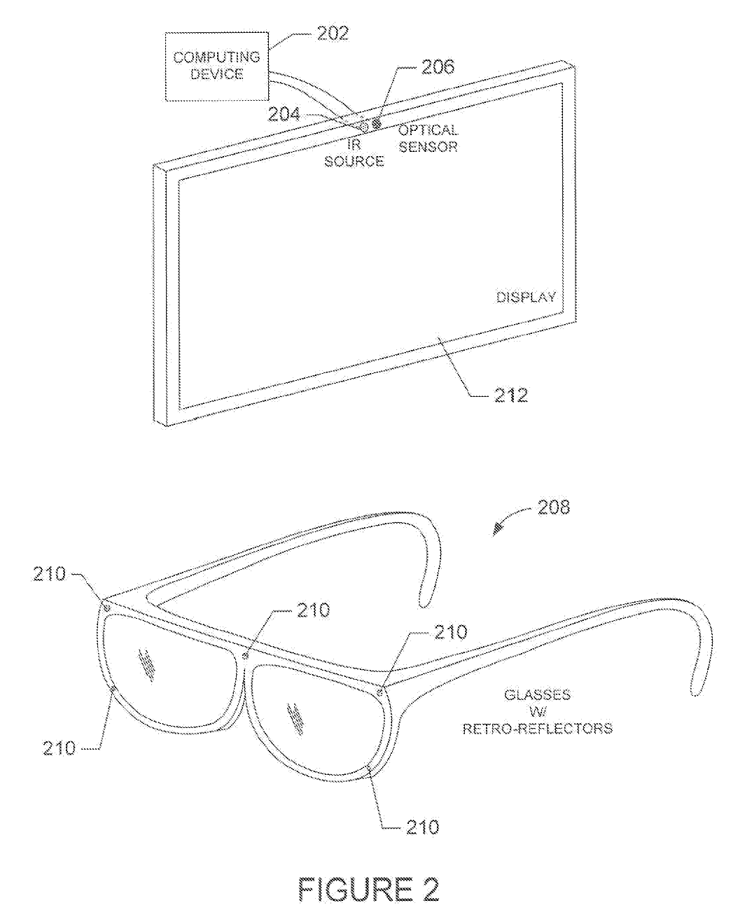

FIG. 2 shows an example of an eye-tracking system 200. The eye-tracking system 200 includes a computing device 202, an IR source 204, an optical sensor 206, and eye glasses 208, which include a number of retroreflectors 210 embedded in the frame of the glasses 208. As shown in the example of FIG. 2, the IR source 204 and optical sensor 206 are located adjacent to each other and can be embedded in the frame of a display 212. The IR source 204 emits IR light which is not detectable by the human eye and is scattered by objects located in front of the display 212. The optical sensor 206 includes an IR sensor and is operated like a camera by capturing IR images of the objects located in front of the display 212. The computing device controls operation of the IR source 204 and optical sensor 206 and processes the IR images captured by the optical sensor 206. The retroreflectors 210 are configured to reflect IR light back toward the IR source 204 and detected by the optical sensor 206.

Although embodiments of the present invention are described with reference to using eye glasses 208, system and method embodiments of the present invention are not intended to be so limited. Instead of using eye glasses 208, the retroreflectors 210 can be embedded in any other suitable headgear, such as a head band, goggles, or a cap, that can be worn by the user, provided the retroreflectors are positioned near the wearer's face and reflected in the direction in which the wearer's face is pointing.

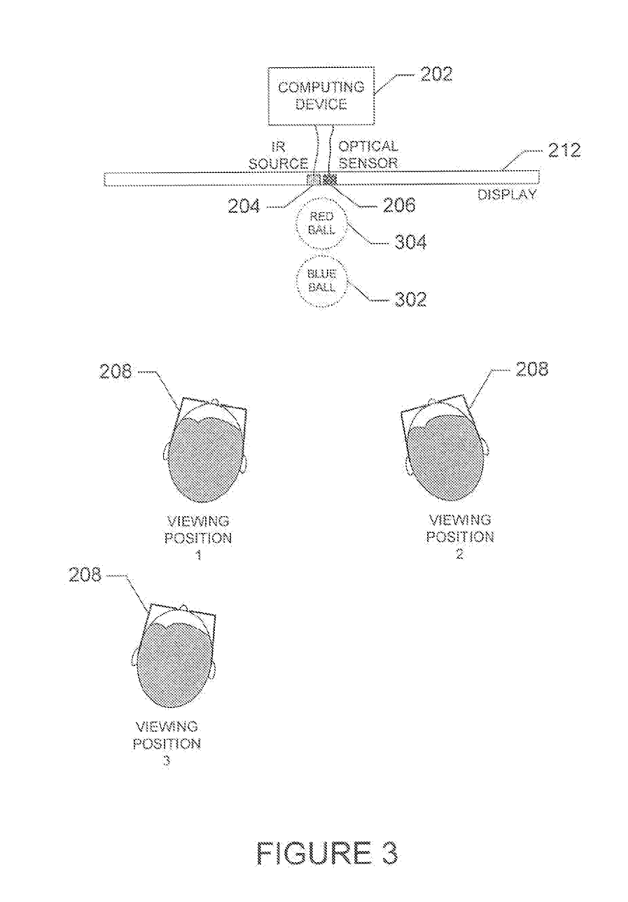

When the display 212 is operated as a three-dimensional display, the eye tracking system 200 can enhance the three-dimensional viewing experience as follows. FIG. 3 shows a top plan view and example of the system 200 used to enhance a three-dimensional viewing experience. The display 212 is operated to provide the person with different perspective view images of a blue ball 302 located in front of a red ball 304 depending on where the person is located in front of the display 212. Consider a person initially located at viewing position 1. The IR source 204 emits IR light that is reflected back toward the optical sensor 206 by the retroreflectors (not shown) located around the frame of the glasses 208. The IR light reflected by the glasses 208 and captured by the optical sensor 206 is processed by the computing device 202 and used to determine the location and head orientation of the person in front of the display 212. As a result, the display 212 is operated to show a perspective view image of the red ball 302 and the blue ball 304 associated with viewing the display 212 from a particular viewing position. For example, at viewing position 1, the person sees the red ball 304 located to the left and behind the blue ball 302. When the person moves to viewing position 2, the person's location and head orientation are changed. The IR light reflected by the glasses 208 and captured by the optical sensor 206 is processed by the computing device 202 resulting in the display 212 operated to show a perspective view image of the red ball 304 and the blue ball 302 from viewing position 2. The person sees from viewing position 2 the red ball 304 located to the right and behind the blue ball 302. When the person moves to viewing position 3, the person's head orientation is similar to the person's head orientation when the person was located at viewing position 1, but the person is located farther from the display 212. As a result, the display 212 can be operated to show substantially the same perspective view image of the red ball 304 and the blue ball 302 as seen from viewing position 1, but with the red ball 304 and blue ball 302 appearing smaller in order to enhance the visual effect of moving farther from the display 212.

In certain embodiments, the perspective view images can be two-dimensional perspective views that can be used to create a three-dimensional viewing experience for the person as the person watches the display 212 and moves to different viewing positions in front of the display 212. In other embodiments, the perspective view images can be three-dimensional perspective views that can be viewed from different viewing positions as the person changes viewing positions. The three-dimensional perspective views can be created by presenting the person with alternating right-eye and left-eye stereoscopic image pairs.

In certain embodiments, the glasses 208 can be battery operated active shutter glasses with liquid crystal display (“LCD”) shutters that can be operated to open and close. Three-dimensional viewing can be created by time division multiplexing alternating opening and closing if the left-eye and right-eye shutters with alternating the display of left-eye and right-eye images pairs. For example, in one time slot, the right eye shutter can be closed while the left-eye shutter is open and a left-eye perspective view image is displayed on the display 212. And in a subsequent time slot of approximately equal duration, the right eye shutter can be open while the left-eye shutter is closed and a right-eye perspective view image is displayed on the display 212.

In other embodiments, the glasses 208 can be passive glasses, such as polarization or wavelength filter glasses. With polarization filter glasses, the left and right eye lenses of the glasses can be configured with orthogonal polarizations. For example, the left-eye lens can transmit horizontally polarized light and the right-eye lens can transmit vertically polarized light. The display 212 can be a screen where a left-eye perspective view image is projected onto the display 212 using horizontally polarized light and the right-eye perspective view image is projected onto the display 212 using vertically polarized light. In other embodiments, right and left circularly polarization filters can be used. In still other embodiments, the glasses 208 can be wavelength filtering glasses. For example, with wavelength filtering glasses, the left and right eye lenses of the glasses can be configured to transmit different portions of the red, green, and blue portions of the visible spectrum. In particular, the left-eye lens is a filter configured to transmit only a first set of red, green, and blue primary colors of light, and the right-eye lens is a filter configured to transmit only a second set of red, green, and blue colors of light. The left-eye perspective view image is projected onto the display 212 using the first set of primary colors, and the right-eye perspective view image is projected onto the display 212 using the second set of primary colors.

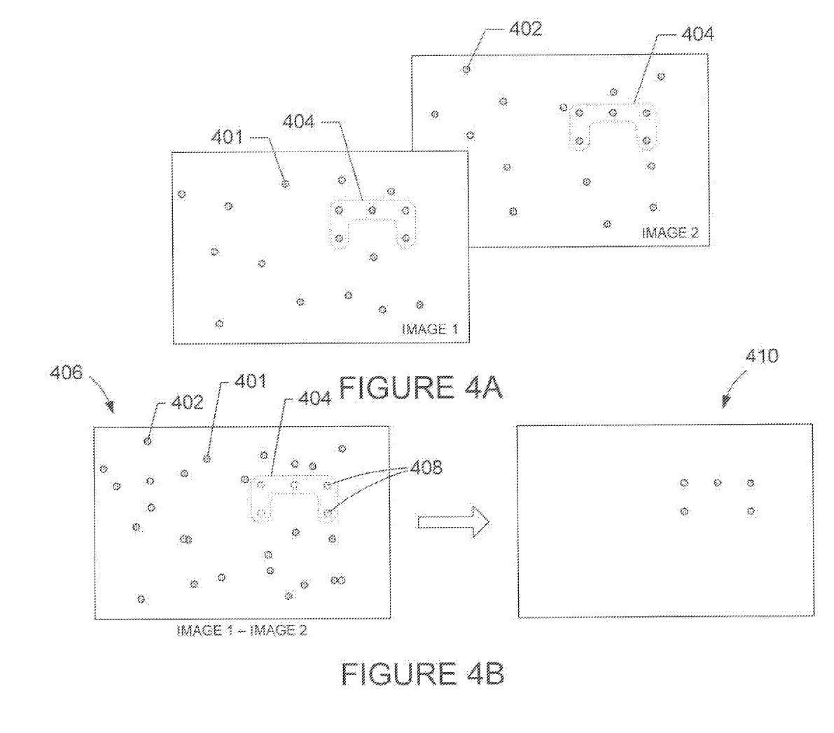

Methods and systems for determining the location and head orientation of person using the system 200 is now described with reference to FIGS. 4-10.

Embodiments of the present invention include methods for determining the location of a person in uncontrolled light conditions where spurious IR light is captured by the optical sensor 206 along with the IR light emitted by the IR source 204. In order to eliminate the spurious IR light in the images captured by the optical sensor 206, the IR source 204 is turned “on” and “off” for each image captured by the optical sensor 206. Subtraction of two consecutive images reveals only the areas of the images illuminated by the IR source 204, thereby reducing the possibility of other IR light interfering with the localization of the person.

FIG. 4A shows consecutive images, identified as image 1 and image 2, captured by the optical sensor 206. The IR light captured in each image is represented by dots, such as dots 401 and 402. The IR light reflected from the retroreflectors of the glasses 208 are outlined in both images by an enclosure 404. Dots located outside the enclosure 404 represent spurious IR light captured by the optical sensor 206. In both images, the dots associated with the retroreflectors of the glasses 208 are indistinguishable from the dots associated with spurious IR light sources, making it difficult to identify the retroreflectors of the glasses worn by the person. However, when image 2 is subtracted from image 1, dots associated with the IR light reflected from the retroreflectors of the glasses 208 are not present in the subtracted image. FIG. 4B shows the subtracted image 406 resulting from subtracting the image 2 from the image 1. Because the spurious IR sources appear in substantially different locations in images 1 and 2, when the image 2 is subtracted from the image 1 the dots associated with spurious IR light in both images appear in the subtracted image 406, such as dots 401 and 402. On the other hand, because the IR light reflected by the retroreflectors of the glasses 208 appear in substantially the same locations in the images 1 and 2, the dots associated with retroreflectors are missing in the subtracted image 406 as indicated by open dots 408. The missing dots can be used to identify IR light produced by the retroreflectors of the glasses, which are represented in image 410.

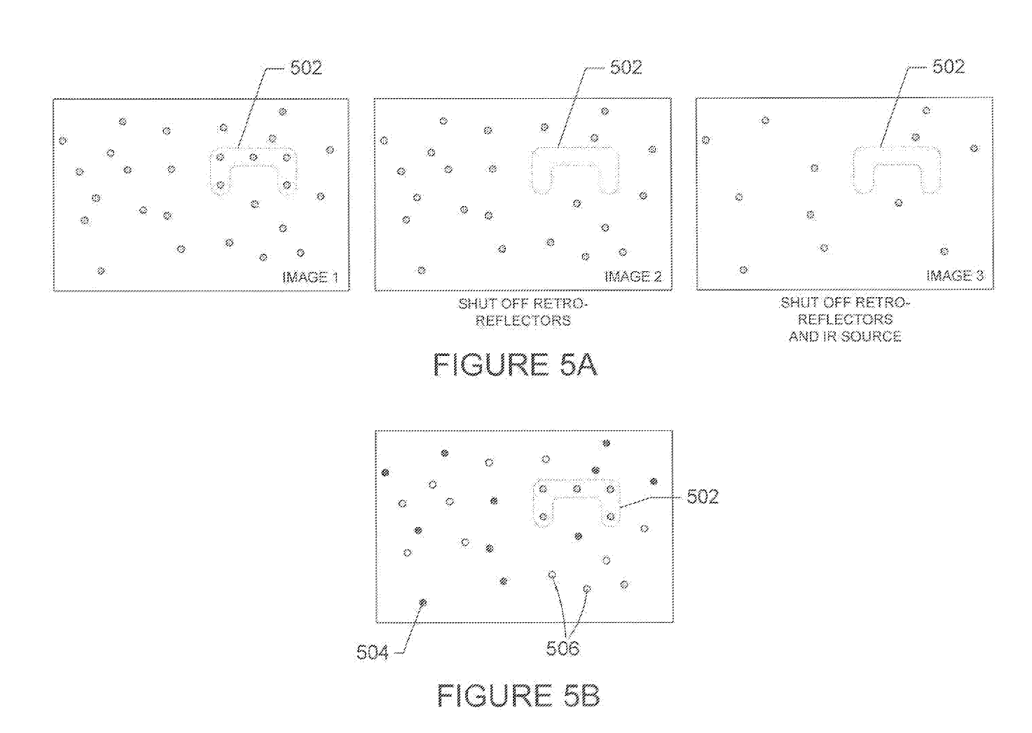

Embodiments of the present invention can also be configured to identify reflections that occur naturally in other reflective surfaces, such as jewelry and glass. In certain embodiments, the shutter glasses can be configured with LCD shutters covering the retroreflectors and an IR light detector so that opening and closing of the LCD shutters can be controlled by the IR source 204. FIG. 5A shows three consecutive images identified as images 1-3. Image 1 is captured by the optical sensor 206 when the IR source is “on” and the shutters covering the retroreflectors are open. Thus, the dots of image 1 represent the IR light associated with other IR sources, the IR light reflected from other surfaces, and the IR light generated by IR source 204 and reflected by retroreflectors. In image 1, the IR light reflected from the retroreflectors of the glasses are identified by enclosure 502. Image 2 is captured by leaving the IR source “on” but the retroreflector shutters are closed. This image reveals IR light associated with other IR sources and the IR light reflected by other surfaces. The dots missing from enclosure 502 represent the retroreflectors closed to reflecting IR light. Image 3 is captured by turning the IR source “off” and leaving the retroreflector shutters closed. This image reveals IR light associated with other sources. The three consecutive images 1, 2, and 3 can be used to identify the IR light sources in the images captured by the optical sensor 206. FIG. 5B shows dots associated with different IR light sources. Dark shaded dots 504 represent the IR light associated with other sources and correspond to the dots represented in image 3. Open circles 506 represent the IR light reflected by other surfaces, which is obtained by subtracting the image 3 from the image 2. The dots associated with retroreflectors 502 can be obtained by subtracting the image 2 from the image 1.

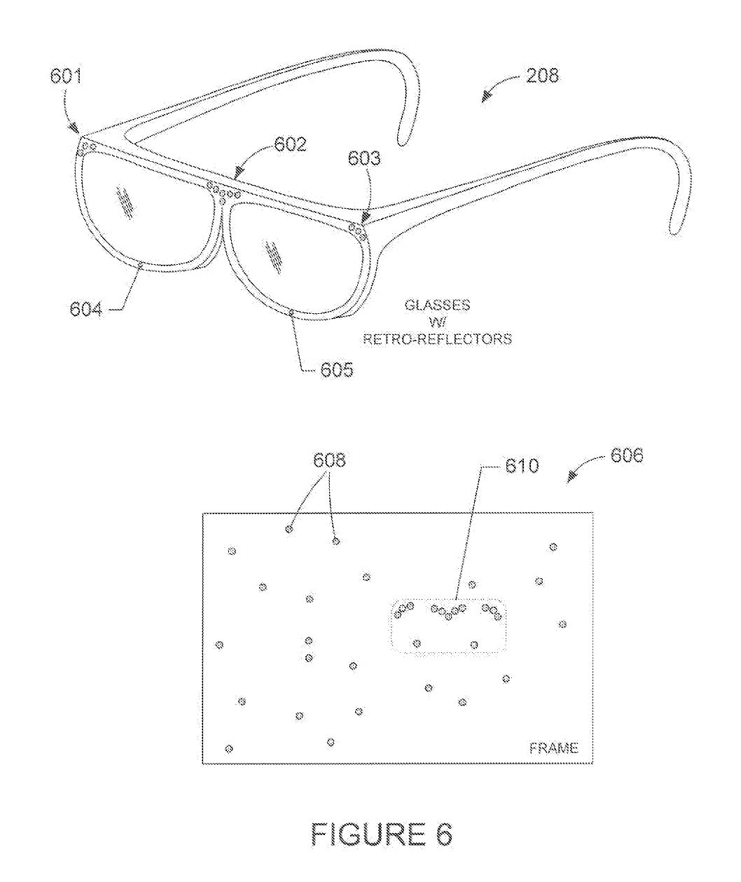

Embodiments of the present invention included arranging the retroreflectors on the frames of the glasses to produce an identifiable reflection pattern of IR light that can be used to locate the person in an image captured by the optical sensor 206. FIG. 6 shows an isometric view of the glasses 208 configured with a particular pattern of retroreflectors. The glasses 208 can be passive glasses. The retroreflectors of grouping 601-603 and retroreflectors 604 and 605 are disposed and arrange on the frame of the glasses 208 to reflect an identifiable pattern of IR light, which can be identified in the image using pattern-matching computer vision techniques. FIG. 6 includes an IR image 606 associated with an image captured by the sensor. The image 606 shows dots 608 associated with spurious IR light sources captured in the image 606 and an identifiable pattern of dots located within enclosure 610 that corresponds to the pattern of retroreflectors disposed on the frame of the glasses 208.

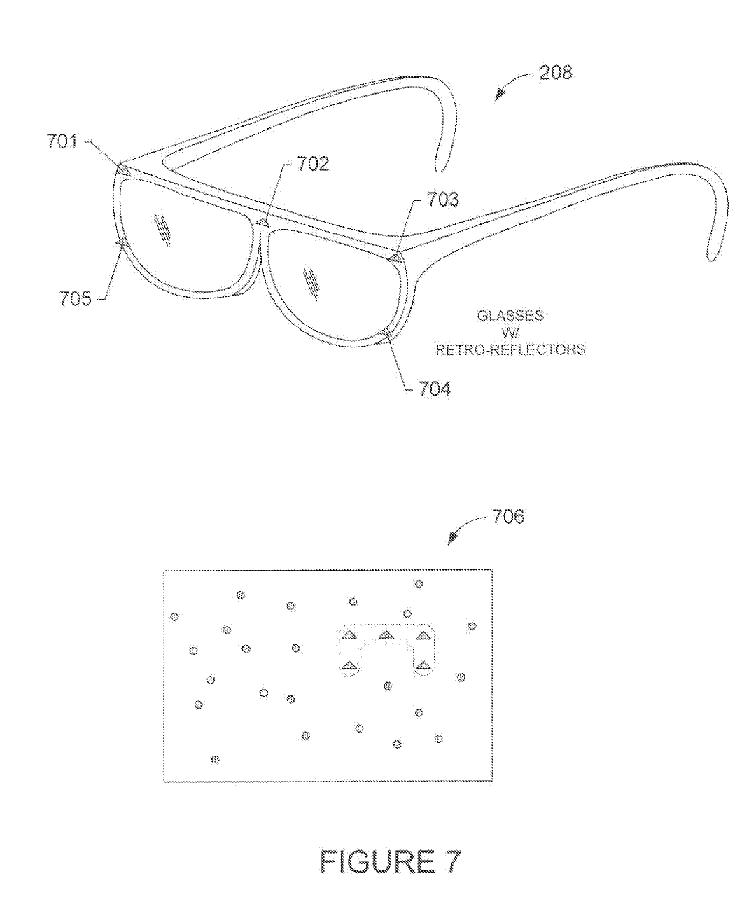

Embodiments of the present invention include retroreflectors that produce identifiable shapes in IR images captured by the optical sensor 206 and can be used to locate the person in the IR images. FIG. 7 shows an isometric view of the glasses 208 configured with a retroreflectors 701-705 that each reflect light with an identifiable shape. The glasses 208 can be passive glasses. As show in the example of FIG. 7, each of the retroreflectors disposed on the frame of the glasses 208 reflects IR light with an identifiable shape represented by a triangle, which can be identified in the image using pattern-matching computer vision techniques. FIG. 7 includes an IR image 706 captured by the optical sensor 206. The image 706 shows dots 708 associated with spurious IR light sources and identifiable triangular shapes located within enclosure 710 that correspond to the shapes reflected by the retroreflectors 701-705 disposed on the frame of the glasses 208.

Note that in other embodiments, by using retroreflectors that reflect IR light with an identifiable shape it is not necessary to also arrange the reflectors in a particular pattern as shown in FIG. 7. Thus, in other embodiments, the number of retroreflectors disposed on the frame of the glasses can be as few as one retroreflector that reflect light with a particular identifiable shape.

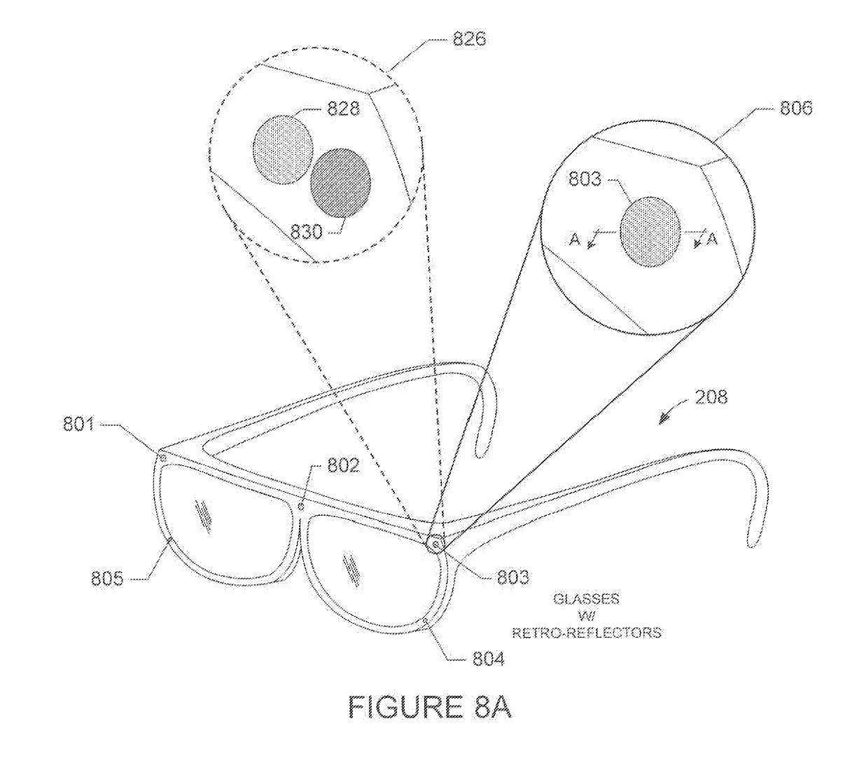

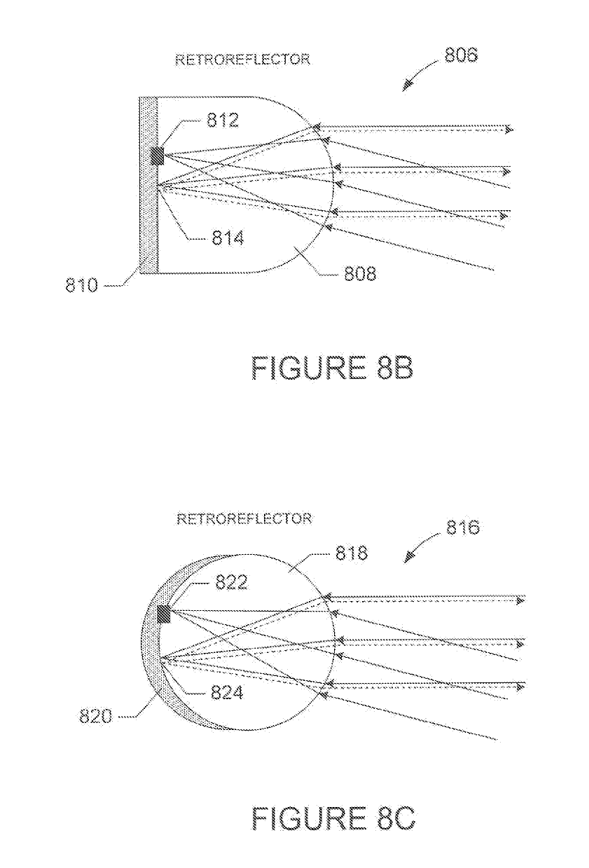

Embodiments of the present invention include retroreflectors that provide head orientation information. Retroreflectors can be fabricated as microlens arrays or glass beads with planar or curved back surfaces and materials deposited on the back surface of the reflectors to reflect IR light back toward the IR source only in certain directions. FIG. 8A shows the glasses 208 configured with five retroreflectors 801-805 and an enlargement 806 of an example retroreflector 803. FIGS. 8B-8C show cross-sectional views of two different kinds of the retroreflectors that can be used in the glasses 208. In FIG. 8B, the retroreflector 806 includes a planar-convex lens 808, a retroreflective surface 810 attached to the planar surface of the lens 808, and at least one black spot 812 for absorbing light. Light, represented by solid-line rays, that is incident on the lens 808 and focused onto a spot 814 of the retroreflective surface 810 is reflected from the spot 814, as represented by dashed-line rays, and emerges from the lens 808 traveling substantially in the same direction as the incident rays. However, light incident on the lens 808 from directions in which the light is focused onto the black spot 812 is absorbed. In FIG. 8C, the retroreflector 816, called a “cat's eye,” includes a spherical lens 818, a reflective surface 820 attached to a portion of the outer surface of the lens 818, and at least one black spot 822 for absorbing light. The retroreflector 816 operates in the same manner as the retroreflector 806. Light that is incident on the lens 818 and focused onto a spot 824 of the reflective surface 820 is reflected and emerges from the lens 818 traveling substantially in the same direction as the incident rays. However, light incident on the lens 818 from directions in which the light is focused onto the black spot 822 is absorbed.

In certain embodiments, the retroreflective surface material 810 and reflective surface material 820 from which light is reflected can be configured to reflect IR light incident from different directions to be reflected with different shapes that can be captured in images by camera. In other words, for IR light that is incident and reflected as shown in FIG. 8B, the shape of the reflected light can be different from the shape of the light reflected from different regions of the retroreflective surface 810.

In other embodiments, the retroreflectors can be configured to only reflect light that is incident from a particular direction and not reflect light that is incident from other directions in order to identify the person's head orientation. Returning to FIG. 8A, when the retroreflectors are configured to have a material that absorbs light incident from any direction, two or more retroreflectors can be used as represented in enlargement 826. Retroreflector 828 can be configured to reflect IR light back toward the IR source when the person's head is in a first orientation.

Alternatively, retroreflector 830 can be configured to reflect IR light back toward the IR source when the person's head is in a second orientation. In still other embodiments, the retroreflector 828 can be configured to reflect IR light with one shape when the person's head is the first orientation, and the retroreflector 830 can be configured to reflect IR light with another shape when the person's head is the second orientation.

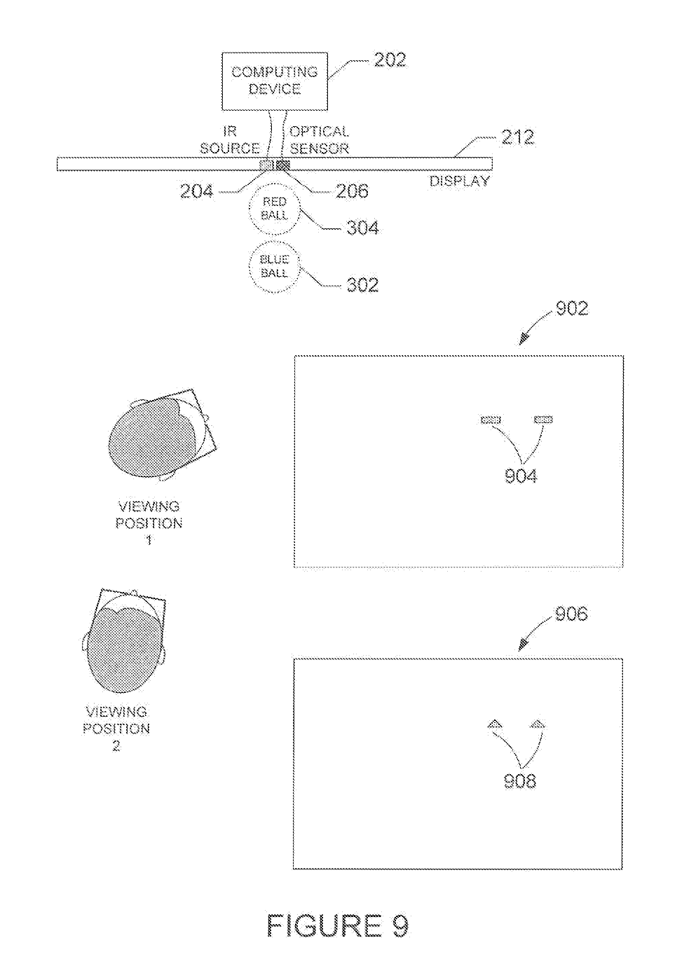

The retroreflectors described above with reference to FIG. 8 can be used to determine head orientation by reflecting IR light with a first shape when the person is facing the optical sensor and reflecting IR light with a second shape when the person is facing away from the optical sensor. FIG. 9 shows an example of using retroreflectors that reflect light with different shapes when the person's head is in different orientations. IR image 902 shows two bars 904 of IR light reflected back toward the IR source 204 when the person's face is turned away from the optical sensor 206. As a result, rather than switching the perspective view to a farther away perspective view, as described above with reference to FIG. 2, the same perspective presented to the person in viewing position 1 is maintained, because when the bars 904 are detected the computing determines the person has not moved farther away from the display 212 but has simply turned his head. On the other hand, IR image 906 shows two triangles 908 of reflected light when the person is facing the optical sensor 206. The triangles indicate that the person is facing the optical sensor 206, or display 212, and the computing device can determine based detection of the triangles that the person is facing the display 212 and use the spacing between the triangles can determine the person's approximate distance from the display.

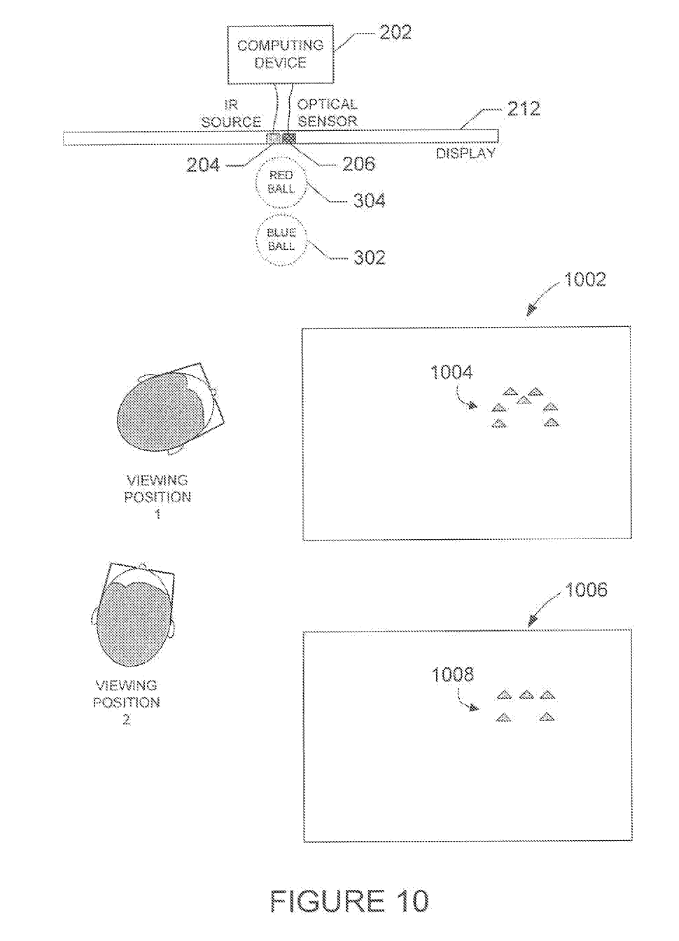

The retroreflectors described above with reference to FIG. 8 can also be used to determine head orientation by reflecting IR light with a first reflection pattern when the person is facing the optical sensor and reflecting IR light with a second reflection pattern when the person is facing away from the optical sensor. FIG. 10 shows an example of using retroreflectors that reflect light with different reflection patterns when the person's head is in different orientations. IR image 1002 shows a first reflection pattern of triangles of IR light reflected back toward the IR source 204 when the person's face is turned away from the optical sensor 206. As a result, rather than switching the perspective view to a farther away perspective view, as described above with reference to FIG. 2, the same perspective presented to the person is maintained. On the other hand, IR image 1006 shows a second reflection pattern of triangles 1008 reflected light when the person is facing the optical sensor 206. The triangles indicate that the person is facing the optical sensor 206, or display 212, and the computing device 202 can determine based on the pattern 1008 that the person is facing the display 212 and use the spacing between the triangles to determine the person's approximate distance from the display.

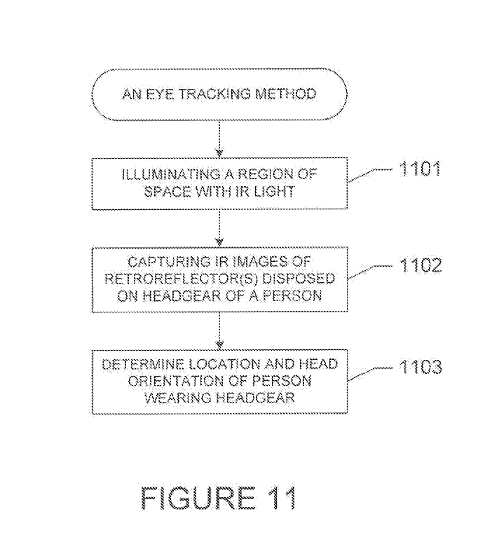

FIG. 11 shows a flow diagram summarizing a method of eye tracking. In step 1, a space occupied by a person is illuminated with IR light using an IR source, as described above with reference to FIG. 2. In step 1102, one or more IR images of the IR light reflected from one or more retroreflectors disposed on headgear worn by the person are captured using an optical sensor, as described above with reference to the example shown in FIGS. 4-10. In step 1103, the location and head orientation of the person is determined based on the one or more IR images, as described above with reference to examples show in FIGS. 4-10.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. An eye tracking system (200) comprising:
a light source (204) configured to emit infrared (“IR”) light;
an optical sensor (206) disposed adjacent to the light source and configured to detect IR light; and
one or more retroreflectors (210) disposed on headgear, wherein the one or more retroreflectors are configured to reflect the IR light back toward the light source, and wherein the reflected IR light is captured as IR images by the optical sensor, the IR images provide information regarding the location and head orientation of a person wearing the headgear.

2. The system of claim 1, wherein the one or more retroreflectors disposed on the headgear further comprises the retroreflectors arranged to produce an identifiable reflection pattern in the IR images (402,502,610).

3. The system of claim 1, wherein each of the one or more retroreflectors disposed on the headgear further comprises the retroreflectors configured to produce identifiable shapes in the IR images (706,905,908).

4. The system of claim 1, wherein each of the one or more retroreflectors disposed on the headgear further comprises the retroreflectors configured to produce identifiable shapes in the IR images and the retroreflectors are arranged to produce an identifiable reflection pattern in the IR images.

5. The system of claim 1, wherein each of the one or more retroreflectors further comprise a lens (808) having a back planar surface with a first material (810) and a second material (812) deposited on the planar surface, wherein the first material reflects IR light back toward the light source when the incident IR light is incident in a first direction and the second material reflects IR light back toward the IR source when the incident IR light is incident in a second direction.

6. The system of claim 1, wherein each of the one or more retroreflectors further comprise a lens (808) having a back planar surface with a first material (810) and a second material (812) deposited on the planar surface, wherein the first material reflects IR light back toward the light source when the incident IR light is incident in a first direction and the second absorbs the IR light incident from any direction.

7. The system of claim 1, wherein the one or more retroreflectors are configured to reflect IR light with a first shape (908) when the person is facing the optical sensor and reflect IR light with a second shape (904) when the person is facing away from the optical sensor.

8. The system of claim 1, wherein the one or more retroreflectors are configured to reflect IR light with a first reflection pattern (1008) when the person is facing the optical sensor and reflect IR light with a second reflection pattern (1004) when the person is facing away from the optical sensor.

9. The system of claim 1, further comprising:
a display (212); and
a computing device (202) is electronic communication with the light source and the optical sensor, wherein the display is operated to present the person a perspective view of a scene based on the person's location and head orientation.

10. An eye tracking method comprising:
illuminating a space occupied by a person with infrared (“IR”) light (1101);
capturing one or more IR images of the IR light reflected from one or more retroreflectors disposed on headgear worn by the person using an optical sensor (1102); and
determining the location and head orientation of the person based on the one or more IR images (1103).

11. The method of claim 10, wherein determining the location of the person based on the one or more IR images further comprises subtracting consecutive IR images in order to identify the IR reflections in the IR image associated the one or more retroreflectors.

12. The method of claim 10, wherein determining the location of the person based on the one or more IR images further comprises:
capturing a first IR image, a second IR, and third IR image;
identifying IR light associated with other IR sources, the IR light reflected from other surfaces, and the IR light generated by IR source in the first image;
identifying IR light associated with other IR sources and the IR light reflected from other surfaces in the second image; and
identifying IR light associated with other IR sources in the third image, wherein the first, second, and third IR images are compared to identify the IR light generated by the IR source.

13. The method of claim 10, wherein determining head orientation further comprises reflecting IR light with a first shape when the person is facing the optical sensor and reflecting IR light with a second shape when the person is facing away from the optical sensor.

14. The method of claim 10, wherein determining head orientation further comprises reflecting IR light with a first reflection pattern when the person is facing the optical sensor and reflecting IR light with a second reflection pattern when the person is facing away from the optical sensor.

15. The method of claim 10, further comprising displaying a perspective view of a scene on a display (212) based on the person's location and head orientation using a computing device (202).
